(19) United States
(12) Patent Application Publication
(10) Pub. No.: US 2004/0128694 A1
(43) Pub. Date: Jul. 1, 2004

(54) Fast selection of media streams

(75) Inventors: David F. Bantz, Bedford Hills, NY (US); Martin G. Kienzle, Briarcliff Manor, NY (US); Steven J. Mastrianni, Unionville, CT (US); Ajay Mohindra, Yorktown Heights, NY (US)

Correspondence Address: STEVEN FISCHMAN, ESQ., SCULLY, SCOTT, MURPHY AND PRESSER, 400 Garden City Plaza, Garden City, NY, 11530, US

(73) Assignee: INTERNATIONAL BUSINESS MACHINES CORPORATION, ARMONK, NY

(21) Appl. No.: 10/334,453

(22) Filed: Dec. 30, 2002

(51) Int. Cl. H04N 7/173

(52) U.S. Cl. 725/95; 725/96; 725/88; 725/102

(57) ABSTRACT

A system and method for permitting an end user to select a media stream and immediately experience the audio and video of that stream, in order to evaluate whether the stream is appropriate to the user's interests and needs. The invention implements a multi-channel receiver that is actively receiving multiple streams, simultaneously. In a preferred aspect, the bandwidth requirements necessary to convey multiple streams, e.g., those communicated on the same network branch, is reduced. Further, the resource requirements of the multi-channel receiver device are reduced for enabling a user to select from among the received multiple streams. A novel user interface is provided that enables fast selection of a pre-acquired stream and, playback of the stream content immediately upon selection.

### BACKGROUND OF THE INVENTION

1. Field of the Invention

The present invention relates generally to devices for receiving media streams in computers, and more particularly, to a multi-channel receiver system and methodology that enables end user selection of a media stream that immediately enables the user to experience the audio and video of that stream, in order to evaluate whether the stream is appropriate to that user's interests and needs.

2. Description of the Prior Art

In current practice, broadcast media (TV, radio) are distributed to receivers that have essentially no latency. That is, no perceptible time elapses from the moment that the media is selected to the time that visible and audible components of the media are seen and heard by the user. Users have become accustomed to this characteristic and often use it to screen alternative media choices by “channel surfing,” rotating a dial on a radio or by using an auto-search facility that tunes to every available radio station in frequency order, pausing a preset time at each station. The user can halt the search at any time by interacting with the radio. In video, picture-in-picture permits monitoring alternative video choices while the user's primary attention is focused on a larger image. Auto-search can also apply to the picture-in-picture image.

Media streaming over the Internet uses receivers that have significant latency. That is, a perceptible and often significant amount of time elapses from the moment that the media is selected to the time that visible and audible components of the media are seen and heard by the user. This is because the Internet does not carry messages with guaranteed quality of service, but rather attempts to deliver all messages on a “best efforts” basis. Since messages may be delayed or even dropped and retried, media receivers buffer several messages of the media stream before playing any audio or video. The buffering delay can amount to as much as half a minute.

Accordingly, the experience of Internet media stream selection is quite different from that for broadcast media, and requires somewhat more care on the part of the end user. The navigation means for selecting a media stream may give static or pseudo-static images from the stream, together with descriptive information about the stream (e.g., album labels). All these are designed to give the end user more information before he or she invests the time necessary to select the stream, wait during the buffering delay and finally evaluate the stream by listening to it and watching it, if possible. The end user may reject the stream almost immediately for many reasons, those including the sound or picture quality or the relevance of the stream to his or her interests. Unfortunately, means are not available for describing the stream in sufficient detail so that the stream can be evaluated solely by its description.

Therefore, a need exists for providing sufficient detail so that a media stream may be described in sufficient detail so that the stream may be evaluated solely by its description in a fast manner. Thus, for example, it would be highly desirable to provide a system and method that permits an end user to select a media stream and immediately experience the audio and video content of that stream, in order to evaluate whether the stream is appropriate to the user's interests and needs.

In a prior art paper entitled “Stream-Bundling Approach to Provide Video Services Over Broadband Networks,” S.-H. Ivan Yeung and S.-H. Gary Chan, in Proceedings of the IS&T/SPIE Conf On Multimedia Computing and Networking 2001, a technique is described for bundling streams into channels, used to deliver the beginning segment of a video to the client so that it can merge with an on-going multicast stream quickly. Although valuable for the problem of video on demand, in which it is necessary for a user to receive an entire stream regardless of the time of request, this scheme is inapplicable to the problem at hand. Similarly, “Pyramid Broadcasting for Video on Demand Service,” S. Viswanathan and T. Imielinski, in Proceeding of IS&T/SPIE Conf. on Multimedia Computing and Networking 1995 describes a complex scheme for breaking a video stream down into a number of segments, so as to provide reduced latency of access for an end user with acceptable network utilization. Since the problem is that of video on demand the solution is inapplicable to the problem at hand.

U.S. Pat. No. 6,310,886 to Barton discloses a method by which network bandwidth can be dynamically allocated between real-time and on-demand use. The subject prior art deals with efficient use of a network by multiple streams. U.S. Pat. No. 6,327,418 also to Barton describes means for implementing such functions as rewind, pause, frame advance and fast forward on a continuous stream. These means, while useful to multi-media receiver systems, do not permit an end user to select a media stream and immediately experience the audio and video content of that stream, in order to evaluate whether the stream is appropriate to the user's interests and needs.

### SUMMARY OF THE INVENTION

It is an object of the present invention to provide a multi-channel receiver system that enables an end user to select a multi-media stream from among of plurality of streams capable of being received by the receiver, and immediately experience the audio and video content of that stream, in order to evaluate whether the stream is appropriate to the user's interests and needs.

It is a further object of the present invention to provide a user interface for a multi-receiver system that enables an end user to select a media stream out of a plurality of channels capable of receiving streaming media (audio and/or video) and immediately experience the audio and video content of that stream, in order to evaluate whether the stream is appropriate to the user's interests and needs.

According to an aspect of the present invention, there is provided a system and method for permitting an end user to select a media stream and immediately experience the audio and video of that stream, in order to evaluate whether the stream is appropriate to the user's interests and needs. The invention implements a multi-channel receiver that is actively receiving multiple streams, simultaneously. Means are described for reducing the bandwidth requirements of conveying multiple streams, e.g., those communicated on the same network branch, and for reducing the resource requirements of the multi-channel receiver device. Although the invention will be described as if the stream is an audio stream, this is not an inherent limitation of the invention, as will be described. The stream can be any form or combination of forms having a visual, audible, multi-media or otherwise perceptible manifestation, including combined streams such as MPEG-4 or ISO 14496 (see http://mpeg.telecomitalialab.com/standards/mpeg-4/mpeg-4.htm).

Advantageously, the system and method for fast video stream selection provides an end user with faster evaluation of streams, reducing the time needed for the end user to determine whether to listen to or view the stream. An added benefit is that the invention provides a user interface that is more familiar to him or her. That is, the user interface is more akin to that of a broadcast television or radio receiver than to hyperlink selection via a browser.

### BRIEF DESCRIPTION OF THE FIGURES

The objects, features and advantages of the present invention will become apparent to one skilled in the art, in view of the following detailed description taken in combination with the attached drawings in which:

FIG. 1 illustrates an overall block diagram of a system including the invention;

FIGS. 2(a) and 2(b) depict two preferred choices for the stream selection user interface; a rotary selector shown in FIG. 2(a) and a linear selector shown in FIG. 2(b);

FIG. 3 depicts a flowchart detailing the software for a multi-channel receiver;

FIG. 4 illustrates an augmented multi-quality multi-channel receiver capable of receiving n+1 streams simultaneously;

FIG. 5 illustrates the internal architecture of the software employed in the server computer of FIG. 1 modified according, to the invention; and,

FIG. 6 illustrates the software control mechanism and method for preventing the gateway from initiating redundant streams from server computers shown in FIG. 1.

### DETAILED DESCRIPTION OF THE PREFERRED EMBODIMENTS

A preferred embodiment of the invention consisting of a description of the method employed and the necessary apparatus will now be described.

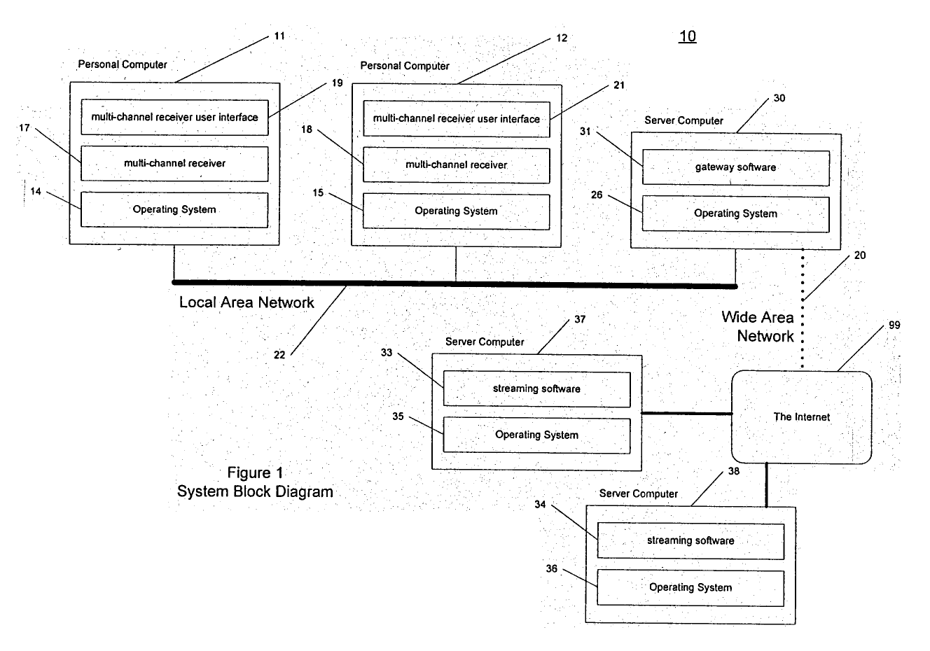

FIG. 1 illustrates an overall block diagram of a system 10 implementing the methodology of the invention. In the FIG. 1 are represented personal computing devices 11 and 12, e.g., PC's, laptops, etc., hosting respective multi-channel receivers 17 and 18, and each comprising a user interface 19 and 21, respectively. Both personal computers 11 and 12 run an operating system 14 and 15 respectively, which provides basic facilities for the support of applications programs such as multi-channel receivers 17 and 18, and facilities for the reproduction of visual and auditory information. Personal computers 11 and 12 illustrated in FIG. 1 additionally play the role of client computers. These computers will initiate streams, decode streams and play the streams for their users.

Additionally shown in FIG. 1 is a server computing device 30 also running an operating system 26 and gateway software 31. This computer acts as a gateway, permitting stream access requests from personal computers 11 and 12 to go on Local Area Network (LAN) 22 to the Internet 99 via Wide Area Network (WAN) link 20, and passing streams from the Internet 99 on to LAN 22 for access by personal computers 11 and 12. The gateway software 31, which is well known in the art, functions as an interface to the Internet and a filter for traffic from it.

Additionally shown in FIG. 1 are two server computers 37 and 38, each running operating systems 35 and 36 together with streaming software 33 and 34. These computers respond to stream access requests from the Internet 99 and provide streams to the Internet 99.

End user stream access is now described with reference to FIG. 1 as a sequence of steps: The multi-channel receivers 17 and 18 are started. These receivers include a pre-stored list of stream identifiers. They issue stream access requests on LAN 22 for all of these streams. Server computer 30 receives these stream access requests from LAN 22 and determines that they are to be relayed to the Internet. Server computer 37 then forwards all of the stream access requests via WAN 20 to the Internet 99.

The Internet 99 determines the destination of these stream access requests to be server computers 37 and 38 and forwards the stream access requests to server computers 37 and 38. The server computers 37 and 38 receive stream access requests and pass them on to the streaming software mechanisms 33 and 34. Streaming software mechanisms 33 and 34 then respond by initiating a broadcast of a stream of messages addressed to personal computers 11 and 12 to the Internet 99. The combination of the Internet 99, WAN 20, server computer 30 and LAN 22 carry the streams of messages to personal computers 1 and 12. The multi-channel receivers 17 and 18 receive the individual messages of each stream and decode them into audio or video samples.

In an initial state, with no stream requests, no streams are being broadcast and no streams are received. Thus, no streams are considered “active”. When a stream is fast selected via a user interface, as described in greater detail herein, the requested stream is broadcast and available for receipt by the user's computer device where it is decoded and fed to a media card in the user's device. It is understood that this stream becomes active when all latencies have been expired. Latency in this context refers to the time a request is received by a server to the time it is broadcast, and includes the time from when it is broadcast to the time it is buffered at the receiver device. Via the interface, one or more potential streams provided in a window of stream selections that may be selected by virtue of their position next to a selected stream, are broadcast and received by the receiver device, and become active. All streams in this window are active, and although not selected, are considered samples which may be discarded, i.e. decoded, but not fed to a media card. Streams associated with selections outside of this window via the interface are not considered requested and are not received, and although these streams may be broadcast, they are not considered active. As soon as the window is moved, by virtue of a user moving the stream selection pointer of the interface to another selection, previously inactive streams that now fall within the window are broadcast, if they have not been broadcast already, and are received and become active.

Thus, a default state of the multi-channel receiver user interface 19 and 21 is a state where no stream is selected and all samples are discarded. However, when a user of personal computer 11 or 12 selects a stream, the samples of that stream are not discarded but sent by multi-channel receivers 37 and 38 to operating systems 14 and for audible or visible reproduction.

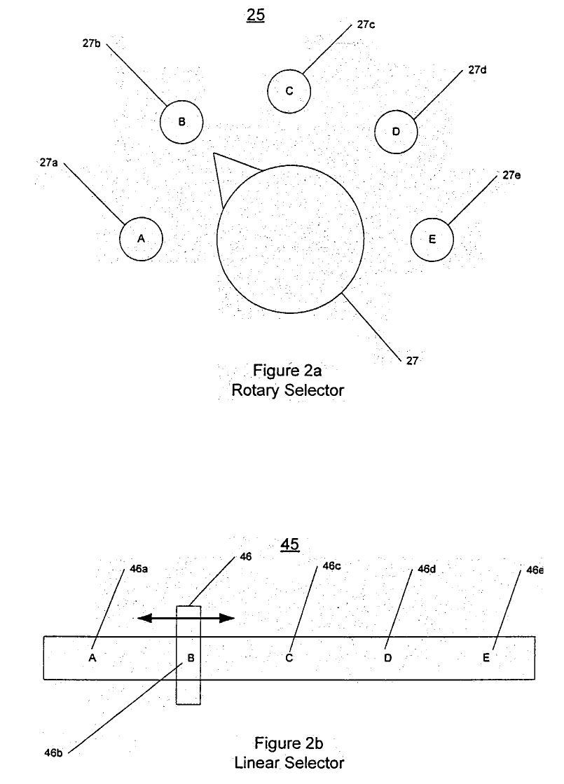

FIGS. 2(a) and 2(b) depict two example multi-channel receiver stream selection user interfaces. In FIG. 2(a), an example multi-channel receiver stream selection user interface comprising a rotary selector 25 is shown. The rotary selector includes a rotary pointer knob 27 with multiple possible selection positions, each marked by a detent label. In the example embodiment shown there are five (5) selectable positions indicated as 27a, 27b, 27c, 27d, and 27e. In use, selecting its pointer with a graphic cursor can enable rotation of the rotary pointer knob 27, and then with mouse movements the knob will rotate appropriately. Although rotation is smooth, the knob “snaps” into each of its possible positions. Each position corresponds to the selection of a predefined stream.

FIG. 2(b) depicts an example multi-channel receiver stream selection user interface comprising a linear selector 45 that includes a linear selector window 46, constrained to move only horizontally, as shown by the double-headed arrow. The window 46 has multiple possible selection positions (five being depicted in FIG. 2(b)), each marked with a detent label 46a, 46b, 46c, 46d and 46e in the example shown. In use, selecting the linear selector window 46 with a graphic cursor can enable movement of the linear selector window 46 horizontally, and then with mouse movements the window will slide appropriately. Although sliding is smooth, the window “snaps” into each of its possible positions. Each position corresponds to the selection of a predefined stream.

It can be seen from the above description and from FIGS. 2(a) and 2(b) that the user interface for stream selection mimics familiar “analog” tuning mechanisms, such as a radio, that of FIG. 2(a) being a tuning knob, and that of FIG. 2(b) being a “slide-rule” dial. It is understood that the mechanisms may be combined so that a pointerless knob is rotated to move a linear selector window, thus exactly mimicking a familiar radio tuning mechanism.

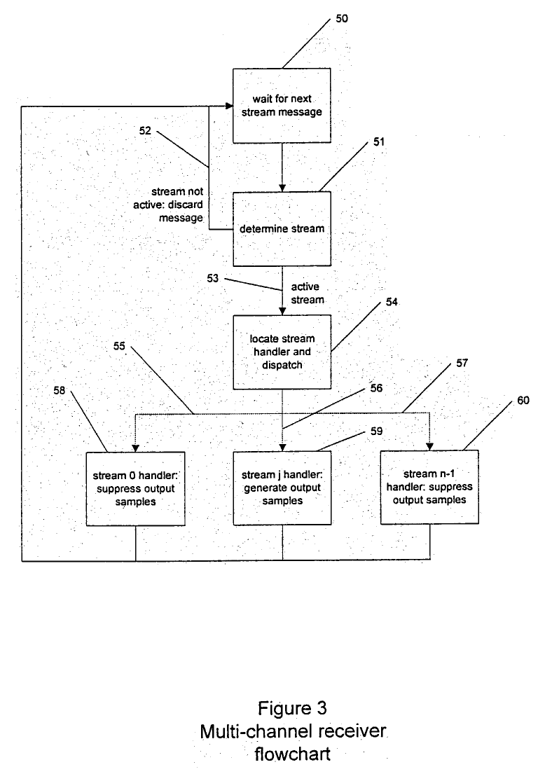

FIG. 3 depicts a flowchart of the software for a multi-channel receiver according to the invention. The receiver is an endless loop that waits for the next stream message, regardless of its source, as indicated in block 50. When the message arrives, it is analyzed by block indicated at step 51 to determine which of the currently active streams it belongs to. If it belongs to a stream that is not active, branch 52 is taken and the message is discarded. If it belongs to an active stream, branch 53, it is taken to block indicated at step 54, where a stream handler for that stream is located. Given that there is a number of “n” active streams numbered 0, 1, . . . , n−1, block 54 may be implemented easily by reference to a table mapper with “n” rows, each row containing a single entry, that entry being a reference to an instance of a stream handler. Stream handlers are instances of a smaller number of stream-handling classes, each specific to the type of encoding found in that stream.

Continuing in view of FIG. 3, one of “n” stream handlers is activated through branches represented in FIG. 3 as branches 55, 56 and 57. Each respective stream handler device 58, 59 and 60 performs encoding-specific processing on the stream message to create output samples. These output samples are, for example, successive samples of digital audio in a format acceptable to operating system functions for audio reproduction. In the FIG. 3, an example situation is depicted such that streams 0 and n−1 are active but not selected, so stream handlers 58 and 60 do not generate output samples. Alternatively, in the case that the operating system functions for audio reproduction and can handle multiple channels of digital audio simultaneously, stream handlers 58 and 60 may generate output samples indicating silence.

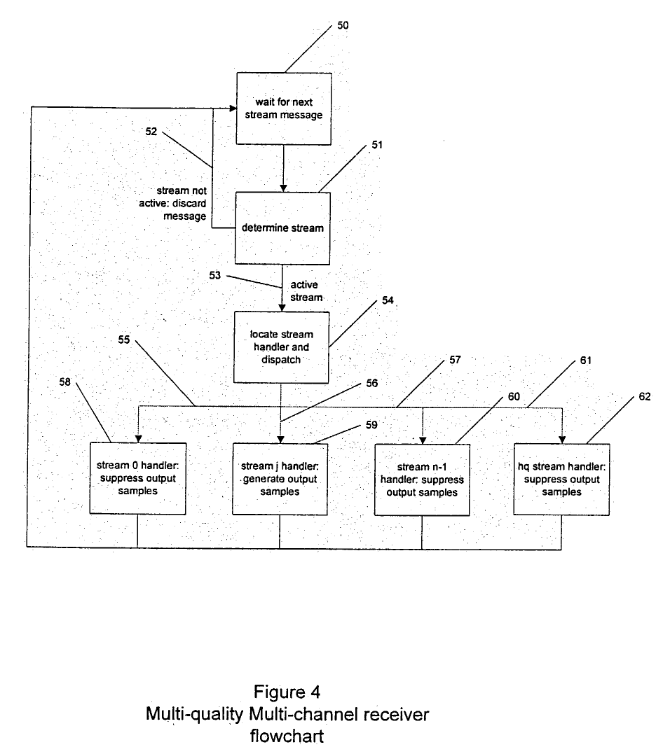

As described with respect to FIG. 3, “n” streams are active and stream messages are received from “n” sources simultaneously. The drawback of this is that network bandwidth is being used unproductively because the end user will be able to hear only one of the streams, that being the selected one. Thus, according to one aspect of the invention, streaming is initiated on all streams simultaneously at some quality level below that which is appropriate for the selected stream. Since no stream is initially selected, all streams will run at limited quality. This still permits the user to listen to a stream at will, without delay. After the user has listened to a stream for some period of time, that period being part of the user's preferences, a new stream will be initiated by the multi-channel receiver at its full quality. As soon as this stream is buffered and output samples are available from it, the lower-quality stream may be terminated. This situation is depicted in FIG. 4, which shows an augmented multi-quality multi-channel receiver according to the invention that is capable of receiving n+1 streams simultaneously.

A flow chart depicting the multi-quality, multi-channel receiver functionality is as depicted in FIG. 4 which is identical to the method of FIG. 3 with the exception that streams 0 through n−1 are all being streamed and decoded at limited quality, even though stream “j” has just been selected. At this time a special stream, stream “hq”, is initiated, which is a duplicate of stream “j” except at higher quality. Stream handler 62 is created to handle this stream and stream “hq” messages cause block 54 to invoke stream handler 62 via branch 61. Initially block 62 suppresses its output samples, but as soon as output samples are available from block 62 they are enabled and the output samples of block 59 are suppressed. At this time block 62 becomes the one and only stream handler for stream j and is known subsequently as the stream handler for stream j.

It is understood that streaming at less than the ultimate quality level of the selected stream makes it possible for the end user to evaluate the content of alternative streams quickly but not their quality. The end user must pause for a time equal to the stream buffering latency in order to hear the quality level improve and make a judgment as to its suitability.

Referring back to FIGS. 2(a) and 2(b), it is understood that an important property of the user interface is thus realized, that of proximity of potential selections. This means that when a user moves the selector from one selection to the next, there are only two candidates that may next be selected. In this optimum implementation, not all streams are active simultaneously. The selected stream is active and streams that may be selected next are active, possibly at lower fidelity. For example, in FIG. 2(a) stream B 27b is shown selected however, it is the case that selection stream candidates 27a, 27c corresponding to streams A and C that are active at lower fidelity may be the next streams selected. Streams D and E may be inactive. If the user rotates rotary pointer knob 26 to position C, stream A can be deactivated, saving network bandwidth and personal computer processing resources. Stream D would then be activated at lower fidelity because it has become potentially the next candidate stream.

In a practical implementation there would be many more possible selections than the five possible positions shown in the example FIGS. 2(a) and 2(b), and the activation or deactivation of streams could be more complex. The “1-neighbors” of a selection are defined to be those positions immediately adjacent to the selection, and the “2-neighbors” to be those selections that are two (2) positions away from the current selection. If it is known that the stream latency is L, and the time that users take to move a pointer from one position to another, adjacent position is T, then all “L/T neighbors” of the current selection should be active. All other selections may be inactive.

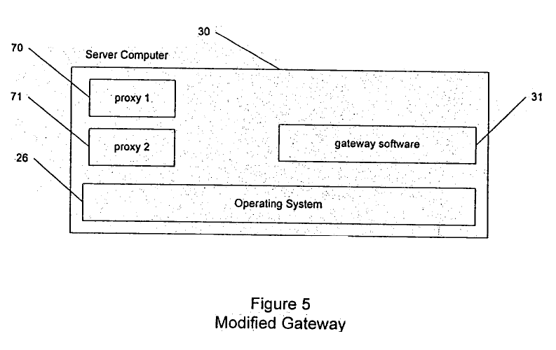

As an enhancement to the function already described, which reduces the bandwidth required from LAN 22, WAN 20 and the Internet 99 of FIG. 1, the function of the server computer 37 in providing a gateway to the Internet 99 is modified. FIG. 5 shows the modified internal structure of software in server computer 37 of FIG. 1. The modifications are seen to include proxy 1 and proxy 2 software blocks indicated as blocks 70 and 71, respectively in FIG. 5. Block 70 (proxy 1) serves personal computer device 11 of FIG. 1 while block 71 (proxy 2) serves personal computer 12 of FIG. 1. Blocks 70 and 71 serve as proxies for server computers 37 and 38 of FIG. 1. They receive stream access requests generated by personal computers 11 and 12 of FIG. 1 and optimize the bandwidth utilization of LAN 22 of FIG. 1 and WAN 20 of FIG. 1 in the manner as will be described in greater detail herein.

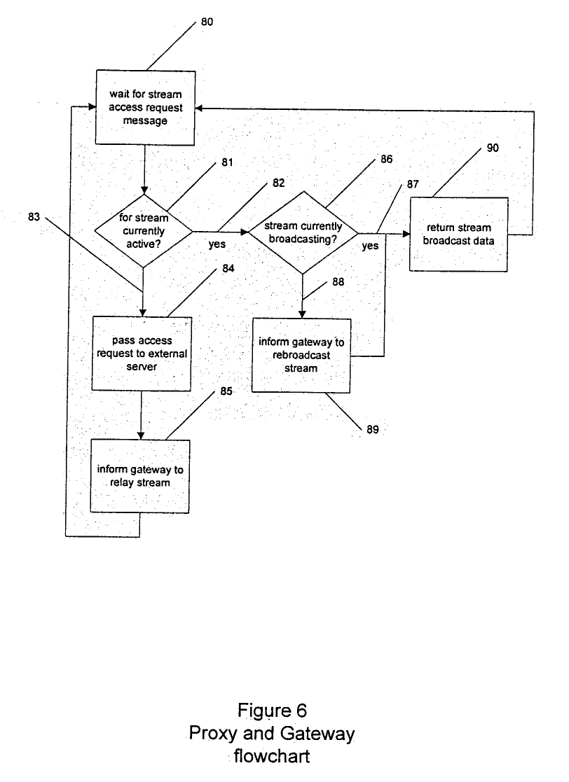

The function of proxy software (blocks 70 and 71) will now be described with respect to FIG. 5 and the flowchart of FIG. 6. Gateway software 11 of FIG. 5 is modified so as to detect stream access request messages from personal computers 11 and 12 of FIG. 1 and pass those messages to proxies 70 and 71 of FIG. 5. Each proxy functions as described in FIG. 6.

In FIG. 6, block 80, there is depicted the step of a proxy waiting for a stream access request. When that request arrives at step 81, a determination is made if it is for a stream that is currently active. If not, branch 83 is taken to block 84, where the stream access request is passed on to the external server on WAN 20 of FIG. 1. Then block 85 records that this stream is now active and informs the gateway to relay the stream once stream messages begin to arrive. The stream is typically carried from servers 37 or 38 in FIG. 1 using a message format such as unicast (uniquely addressed) messages according to a (User Datagram Protocol) or UDP. It is understood that the invention contemplates use of other broadcast messaging formats, besides UDP.

If it is determined at step 81 that the stream is currently active, branch 82 is taken to block 86 which is a determination to see if that stream is currently being broadcast by gateway software 11 of FIG. 5. If the stream is not currently being broadcasted, then branch 88 is taken to block 89, which requests gateway software 11 of FIG. 5 to broadcast the stream, using broadcast messages rather than unicast messages. Broadcast and unicast type messaging formats are described in the text Internetworking with TCP/JP, by Douglas E. Corner, published by Prentice-Hall of Englewood Cliffs, N.J. in 1991, incorporated by reference herein. Proceeding from block 89, and in the case that the stream is currently being broadcast by the gateway as determined at step 86, step depicted at block 90 is entered, which is a step for responding to the stream access request with information enabling personal. computers 11 and 12 of FIG. 1 to receive the broadcast.

The flow chart depicted in FIG. 6 depicts the optimization performed by keeping the gateway from initiating redundant streams from server computers 17 and 1-8 in the architecture illustrated in FIG. 1. Only one copy of a stream is sent to the gateway. If multiple recipients attached to LAN 12 in FIG. 1 request the same stream they receive it via broadcast means.

Stream termination occurs when an original stream requester, either personal computer 111 or 12 in FIG. 1, requests stream termination. In an exemplary manner, let personal computer 1 originate a stream termination message. This message will be passed to proxy 1, block 70 of FIG. 5, which will determine if there is currently exactly one stream user. Only if this is the case, proxy 1 (block 70 of FIG. 5) will relay the stream termination message to the stream source, one of servers 17 or 18 in FIG. 1. Note that if the stream termination request is for a stream with exactly two users, after the above procedure is followed the gateway will still be broadcasting the stream even though there is only one user of it. If this is undesirable, a straightforward extension of the procedure will instruct the gateway to unicast the stream rather than broadcast it in the case that one of the stream's two users has requested to terminate it.

It can be seen that the description given above provides a simple, but complete implementation of fast stream selection through multiple simultaneous streams to a single user, all but one of which produces no perceptible output. Since this increases the number of streams that traverse wide and local area networks, means are provided to use local area broadcast of streams with multiple users, so that no redundant stream copies are required. Similarly, means are provided to access streams through a wide area network in such a manner that no redundant stream copies are required. Finally, user interface means as described herein includes a neighborhood property of stream selections, permitting only those streams likely to be selected to actually be active.

Preferably, the invention is embodied as a software program that runs on a personal computer and, optionally, software that runs on server computers in a computer network. The software that runs on a personal computer includes a multi-channel receiver and a user interface to that receiver. The multi-channel receiver performs a function similar to that of single-channel receivers, of which there are many examples in current practice (e.g., WinAmp, available at http://www.winamp.com/), however unlike the single-receiver case, the multi-channel receiver of the invention may decode multiple streams simultaneously, limited only by the resources available on the computer hosting the multi-channel receiver. The user interface of the multi-channel receiver uses one of a variety of visual representations, preferably similar to analog-type user interfaces such as found on radio receivers.

The multi-channel receiver initiates more than one stream and, after a buffering delay, decodes them all. When the user selects one of the streams, the selection enables the multi-channel receiver to pass decoded audio or video samples from the selected stream to an appropriate subsystem (e.g., sound card, video card). As explained herein, active streams that are not selected cause the multi-channel receiver to generate decoded audio or video samples, but those samples are discarded. The effect is that the audio or video of the stream is immediately available upon selection because the stream has been pre-buffered. The invention also includes means for selecting which streams are to be initiated, and at what streaming rate. The invention also includes means for efficiently distributing multiple streams, given that several users may be accessing streams simultaneously, and their multi-channel receivers may have some streams in common.

Although the invention has been described for audio streams, this is not a limitation of the invention. It can be applied to video streams, combined video and audio streams, streams of sensory data, streams of financial data, and in fact streams of any kind of data, provided that these streams have a real-time perceptual output. Similarly, although the invention has been described for user interface means consisting of a rotating pointer knob and a linear selection dial, any user interface means in which the time to select alternatives is not equal is applicable. Similarly, although the optimization of network bandwidth has been described in terms of two networks, a local area network and a wide area network, the invention is not limited to two networks, but can be applied in more complex networking involving multiple layers of gateways and networks.

In addition to the manual stream selection user interface, depicted in FIGS. 2(a) and 2(b), it is also possible to emulate the capability of modern radio receivers to automatically visit a sequence of stations, pausing at each so that the user can stop the search when a station of interest is heard. This capability is sometimes referred to as “station seek.” A “stream seek” capability which behaves in a manner analogous to “station seek” is thus provided. Stream seek may be initiated by a single button or a pair of buttons, one to initiate a seek in one direction and the other in the opposite direction, for example. When a button is pushed the selector, be it rotary or linear, will move automatically to the next position and the stream at that position will be heard for a period of time. If the seek button is not pressed within that period of time the selector will move to the next position. If the selector reaches the end of its travel the seek may be stopped, or may be continued beginning at the opposite end of the selector travel.

In stream seek, the streams are played in a predictable order; namely, in the order that they appear as selector positions. This permits an optimization that reduces the bandwidth consumed on both local and wide area networks. Streams that are at the current selector position are both active and audible. Streams that have just been visited may be made inactive, so that the bandwidth they consume is no longer consumed. Streams that will be visited next as the stream seek progresses must be made active, but may be broadcast at lower fidelity levels. If it is known that the stream latency is L, and the dwell time of the stream seek (the amount of time the stream seek pauses at each selection) is T, then all streams within L/T positions of the current position in the direction of the seek must be made active.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

1. A method for accessing multiple multi-media data streams for selection by a user at a data stream receiver device, said method comprising the steps of:
(a) acquiring a selected number of streams broadcast from one or more server devices via a network connection;
(b) providing an interface having multiple stream selecting positions for enabling fast switching between stream selections; and,
(c) upon a user fast selection, providing immediate audible or visual reproduction of said stream at said receiver device.

2. The method of claim 1, wherein said acquiring step a) includes the step of initiating simultaneous streaming for one or more said multiple streams from said one or more server devices via said network connection.

3. The method of claim 1, wherein the audible or visual reproduction for said user during said fast stream selection is at a quality level lower than that which is appropriate for the selected stream, said streaming being communicated by said server device at a lower bandwidth.

4. The method of claim 1, wherein prior to user selection of a stream, the step of running all streams at a limited quality, enabling said user to evaluate the content of alternative streams quickly but not their quality.

5. The method of claim 1, wherein said providing step c) further includes the step of initially providing said immediate audible or visual reproduction of said selected stream at said lower quality level; and, after a predetermined time period, the step of initiating a full quality version of said selected stream for reproduction.

6. The method of claim 5, wherein the predetermined time period is a sampling period commensurate with user sampling of the stream at the lower quality level.

7. The method of claim 5, wherein a predetermined time period is set by a user as part of that user's preferences.

8. The method of claim 2, wherein multiple streams that are activated simultaneously include an active stream selected from said interface and streams that may be potentially selected according to its position relative to a position of the selected stream via the interface.

9. The method of claim 7, wherein said streams that may be potentially selected by virtue of its proximate location to said selected stream are active at a lower fidelity

10. The method of claim 7, wherein a number L/T neighbors of the current selected stream are active wherein said “L” represents the stream latency and “T” represents the time for a user to move a pointer of said fast selection interface from one selecting position to another adjacent selecting position.

11. A system for accessing multiple multi-media data streams for selection by a user, said system comprising:
multi-channel receiver device for receiving selected number of data streams broadcast from one or more server devices via a network connection;
user interface device having multiple stream selecting positions for enabling fast switching between stream selections; and,
means for providing immediate audible or visual reproduction of a stream at said multi-channel receiver device in response to the fast selecting.

12. The system of claim 11, further comprising stream handler means for initiating simultaneous streaming for one or more said multiple streams from said one or more server devices via a network connection to enable a user to sample by viewing or listening to stream content immediately upon fast selecting.

13. The system of claim 11, wherein the audible or visual reproduction for said user during said fast stream selection is at a quality level lower than that which is appropriate for the selected stream, said multi-channel receiver device receiving a selected number of streams broadcast from a server device via a network connection at a lower bandwidth.

14. The system of claim 11, wherein said server device initially provides said selected stream at said lower quality level for initial audible or visual reproduction, and, after a predetermined time period, provides a full quality version of said selected stream for reproduction.

15. The system of claim 11, wherein said user interface device enabling fast selection includes a rotary dial including a rotary pointer knob for pointing to one of multiple selecting positions

16. The system of claim 1, wherein said user interface device enabling fast selection includes a linear selector, comprising a linear selector window, capable of movement in a single dimension for pointing to one of multiple selecting positions.

17. The system of claim 12, wherein multiple streams that are activated simultaneously include an active stream selected from said interface and streams that may be potentially selected according to its position relative to a position of the selected stream via the interface.

18. A system for communicating multiple multi-media data streams over a public network comprising:
one or more user computing devices interconnected over a local area network means equipped with a multi-channel receiver device for receiving a selected number of data streams from one or more server devices over a public network, each user computing device including an interface means for initiating fast selection of said data streams to be received and enabling immediate viewing or listening to stream content upon fast selecting via said interface means;
a proxy server device connected to said local area network including means for receiving requests for streaming data from said user computing devices and forwarding the stream requests to one or more content server device capable of providing said requested data streams content over a public communications network and back to said proxy server via a gateway,
said proxy server device including means for eliminating redundancy when communicating a data stream requested by multiple users, and thereby optimizing bandwidth of said local area network and said gateway when simultaneously transmitting requested data streams.

19. The system of claim 18, wherein said gateway includes means for transmitting requested stream content for requested streams via unicast messaging to individual user computing devices.

20. The system of claim 18, wherein said gateway includes means for transmitting requested stream content for requested streams via broadcast messaging, said proxy server device including means for determining whether multiple requests are made for a single stream, and if so, initiating broadcasting of said stream for receipt by multiple user computing devices, whereby only one copy of a stream is sent to the gateway to prevent redundant streams from being sent.

21. A method for communicating multi-media data streams over a public network to one or more user computing devices interconnected by a local area network means, a user computing device having a multi-channel receiver device capable of receiving a selected number of data streams, said method comprising steps of:
(a) receiving requests for streaming data from said user computing devices and forwarding the stream requests to one or more content server devices capable of providing said requested data stream content over a public communications network via a gateway;
(b) initiating simultaneous streaming of one or more said multiple streams from a content server device via said gateway for receipt by a requesting user computing device, said simultaneous streaming including optimizing said bandwidth of said local area network and said gateway for communicating requested multiple data streams simultaneously to a multi-channel receiver device; and,
(c) enabling a user to sample a data stream from said multiple streams by viewing or listening to stream content immediately upon fast selecting of a data stream via said interface.

22. The method of claim 21, wherein said receiving step a) further includes the step of determining whether multiple requests are made for a single stream, and if so, initiating broadcasting of said stream for receipt by multiple user computing devices, whereby only one copy of a stream is sent to the gateway- to prevent redundant streams from being sent.

23. A computer program device readable by a machine, tangibly embodying a program of instructions executable by a machine to perform method steps for accessing multiple multi-media data streams for selection by a user at a multi-channel data stream receiver device, said method steps comprising:
(a) acquiring a selected number of streams broadcast from one or more server devices via a network connection;
(b) providing an interface having multiple stream selecting positions for enabling fast switching between stream selections; and,
(d) upon a user fast selection, providing immediate audible or visual reproduction of said stream at said receiver device.

24. The computer program device as claimed in claim 23, wherein said step a) further includes the step of: initiating simultaneous streaming for one or more said multiple streams from said server device via a network connection to enable a user to sample by viewing or listening to stream content immediately upon selecting.

25. A computer program device readable by a machine, tangibly embodying a program of instructions executable by a machine to perform method steps for communicating multi-media data streams over a public network to one or more user computing devices interconnected by a local area network means, a user computing device having a multi-channel receiver device capable of receiving a selected number of data streams, said method steps comprising:
(a) receiving requests for streaming data from said user computing devices and forwarding the stream requests to one or more content server devices capable of providing said requested data stream content over a public communications network via a gateway;
(b) initiating simultaneous streaming of said multiple streams from a content server device in response to a request via said gateway for receipt by a requesting user computing device, said simultaneous streaming including optimizing said bandwidth of said local area network and said gateway for communicating requested multiple data streams simultaneously to a multi-channel receiver device; and,
(c) enabling a user to sample a data stream from said multiple streams bye viewing or listening to stream content immediately upon fast selecting of a data stream via said interface.
